(19) United States
(12) Patent Application Publication
(10) Pub. No.: US 2020/0088530 A1
(43) Pub. Date: Mar. 19, 2020

(54) SYSTEM AND METHOD FOR SIGNATURE COLLECTION AND MANAGEMENT IN SUPPORT OF PUBLIC INITIATIVES

(71) Applicant: Lean Methods Group, Denver, CO (US)

(72) Inventors: David Silverstein, Longmont, CO (US); Riaan Brits, Boulder, CO (US); Philip Samuel, Lafayette, CO (US); Andrea Beert, Boulder, CO (US)

(21) Appl. No.: 16/131,811

(22) Filed: Sep. 14, 2018

(51) Int. Cl. G01C 21/34; G01C 21/20; G05D 1/02; G01C 21/36; H04W 4/024

(52) U.S. Cl. CPC G01C 21/343; G01C 21/20; H04W 4/024; G01C 21/3626; G05D 1/0212

(57) ABSTRACT

A method and system for signature collection and management in support of public initiatives are described. The described techniques allow an individual to submit a signature collection request in response to an initiative soliciting support. Collection requests are accumulated and used to direct collection agents to visit individuals and collect their signatures. A list of individuals indicating support for a public initiative may be identified, the list including availability information and a geographic location associated with each of the individuals, and a current geographic location of a mobile device may be determined. A subset of the individuals may be selected from the list based on the current geographic location, the availability information, and the geographic locations associated with the plurality of individuals. A route between geographic locations associated with at least two individuals of the subset of the plurality of individuals may be generated, and the route may be output.

### BACKGROUND

The following relates generally to signature collection, and more specifically to managing information associated with an individual's support for a ballot measure.

Ballot measures are typically broken down into ballot initiatives and referendums. An initiative is a proposal for a new law or constitutional amendment introduced by citizens through a petition process either to the legislature or directly to the voters. An initiative is placed on a ballot through the collection of signatures from citizens or voters. A direct initiative is a proposal that qualifies when a requisite number of signatures have been collected and goes directly on a ballot. An indirect initiative is a proposal that is submitted to the legislature, which has an opportunity to act on the proposed legislation. The initiative question will subsequently go on the ballot if the legislature rejects it, submits a different proposal, or takes no action. A ballot initiative represents a topic of interest or concern in support of which citizens are collecting signatures. Initiatives may relate to advisory questions, memorials, statutes, constitutional amendments, and more.

In many US states, citizens can reject laws or amendments proposed by the state legislature, and this process is commonly referred to as the referendum process. A referendum is a proposal to repeal a law that was previously enacted by the legislature, and that is placed on the ballot by citizen petition. There are two types of referendum—popular and legislative. A popular referendum is when the people have the power to refer, by collecting signatures on a petition, specific legislation that was enacted by their legislature for the people to either accept or reject. A legislative referendum is when the state legislatures, an elected official, state appointed constitutional revision commission or other government agency or department submits proposals (constitutional amendments, statutes, bond issues, etc.) to the people for their approval or rejection. Throughout this document the terms referendum, initiative, proposal and measure may be used interchangeably.

Conventional solutions for collecting signatures in support of a public initiative are deficient.

### SUMMARY

The techniques described herein enable voters to indicate their desire or willingness to have their signature recorded and allows them to submit a signature collection request. A signature collect ion request discloses identifying information that tray include information such as a voter's name, preferred signature collection dates and times, and preferred collection locations. The signature collection request may include a specific date, time and collection location. Signature collection requests may used to suggest, recommend or optimize a collection route to be used by a collection agent to collect wet signatures from a collection of voters.

A method for signature collection is described. The method may include identifying a list of a plurality of individuals indicating support for a public initiative, the list including availability information and a geographic location associated with each of the plurality of individuals, determining a current geographic location of a mobile device, selecting, from the list, a subset of the plurality of individuals based at least in part on the current geographic location, the availability information, and the geographic locations associated with the plurality of individuals, generating a route between geographic locations associated with at least two individuals of the subset of the plurality of individuals, and outputting the route.

An apparatus for signature collection is described. The apparatus may include a processor, memory in electronic communication with the processor, and instructions stored in the memory. The instructions may be operable to cause the processor to cause the apparatus to identify a list of a plurality of individuals indicating support for a public initiative, the list including availability information and a geographic location associated with each of the plurality of individuals, determine a current geographic location of a mobile device, select, from the list, a subset of the plurality of individuals based at least in part on the current geographic location, the availability information, and the geographic locations associated with the plurality of individuals, generate a route between geographic locations associated with at least two individuals of the subset of the plurality of individuals, and output the route.

Another apparatus for signature collection is described. The apparatus may include means for identifying a list of a plurality of individuals indicating support for a public initiative, the list including availability information and a geographic location associated with each of the plurality of individuals, means tar determining a current geographic location of a mobile device, means for selecting, from the list, a subset of the plurality of individuals based at least in part on the current geographic location, the availability information, and the geographic locations associated with the plurality of individuals, means for generating a route between geographic locations associated with at least two individuals of the subset of the plurality of individuals, and means for outputting the route.

A non-transitory computer readable medium for signature collection is described. The non-transitory computer-readable medium may include instructions operable to cause a processor to identify a list of a plurality of individuals indicating support for a public initiative, the list including availability information and a geographic location associated with each of the plurality of individuals, determine a current geographic location of a mobile device, select, from the list, a subset of the plurality of individuals based at least in part on the current geographic location, the availability information, and the geographic locations associated with the plurality of individuals, generate a route between geographic locations associated with at least two individuals of the subset of the plurality of individuals, and output the route.

In some examples of the method, apparatus, and non-transitory computer-readable medium described above, selecting the subset of the plurality of individuals further comprises determining a distance between a plurality of pairs of the geographic locations associated with the plurality of individuals, and selecting the subset of the plurality of individuals based at least in part on the determined distances.

In some examples of the method, apparatus, and non-transitory computer-readable medium described above, selecting the subset of the plurality of individuals further comprises determining a density parameter for a plurality of different geographic regions based at least in part on the geographic locations associated with the plurality of individuals, and selecting the subset of the plurality of individuals based at least in part on individuals of the subset being located within a particular geographic region of the plurality of different geographic regions associated within a density parameter that satisfies a density threshold.

In some examples of the method, apparatus, and non-transitory computer-readable medium described above, selecting the subset of the plurality of individuals further comprises determining a motivation parameter associated with a plurality of different geographic regions, and selecting the subset of the plurality of individuals based at least in part on individuals of the subset being located within a particular geographic region of the plurality of different geographic regions associated within a motivation parameter that satisfies a motivation threshold.

In some examples of the method, apparatus, and non-transitory computer-readable medium described above, generating the route further comprises determining an estimated time to proceed along a plurality of different routes based at least on the geographic locations associated with the plurality of individuals, and selecting the route from the plurality of different routes based at least in part on the estimated times. In some examples of the method, apparatus, and non-transitory computer-readable medium described above, each of the estimated times is determined based at least in part on an estimated amount of time to collect a signature.

Some examples of the net hod, apparatus, and non-transitory computer-readable medium described above may further include processes, features, means, or instructions for receiving, from the mobile device, a collection result indicator that indicates whether a signature was successfully collected from a particular individual of the subset of the plurality of individuals. Some examples of the method, apparatus, and non-transitory computer-readable medium described above may further include processes, features, means, or instructions for removing, from the list, availability information and geographic location of the particular individual based at least in part on the collection result indicator indicating successful collection of a signature from the particular individual. Some examples of the method, apparatus, and non-transitory computer-readable medium described above may further include processes, features, means, or instructions for adding, to a completion list, information of the particular individual based at least in part on the collection result indicator indicating successful collection of a signature from the particular individual.

Some examples of the method, apparatus, and non-transitory computer-readable medium described above may further include processes, features, means, or instructions for determining that a defined number of signatures associated with the public initiative have been collected based at least in part on the collection result indicator, and outputting a complete message to indicate that the defined number of signatures have been collected. Some examples of the method, apparatus, and non-transitory computer-readable medium described above may further include processes, features, means, or instructions for determining an updated route based at least in part on the collection result indicator, and outputting the updated route.

In some examples of the method, apparatus, and non-transitory computer-readable medium described above, the availability information indicates a time period and a date. In some examples of the mobile device is an autonomous vehicle, and the route comprises directions between a first geographic location associated with a first individual of the subset of the plurality of individuals and a second geographic location associated with a second individual of the subset of the plurality of individuals.

In some examples of the method, apparatus, and non-transitory computer-readable medium described above, the list is generated based at least in part on user input provided via a website or a mobile application. In some examples of the method, apparatus, and non-transitory computer-readable medium described above, outputting the route further comprises causing wireless transmission of a route message comprising the route to the mobile device via a wireless network. In some examples of the method, apparatus, and non-transitory computer-readable medium described above, outputting the route further comprises causing the mobile device to visually display at least a portion of the route.

In some examples of the method, apparatus, and non-transitory computer-readable medium described above, generating the route further comprises generating the route between geographic locations associated with pairs of individuals of the subset of the plurality of individuals. In some examples of the method, apparatus, and non-transitory computer-readable medium described above, estimating an amount of time to collect a defined number of signatures associated with the public initiative based at least in part on the geographic locations associated with each of the plurality of individuals, a number of available collections agents estimated amount of time to collect a signature, or any combination thereof.

### BRIEF DESCRIPTION OF DRAWINGS

FIG. 1 illustrates an example of a system for collecting signatures in accordance with aspects of the present disclosure.

FIG. 2 illustrates an example of a process flow in accordance with aspects of the present disclosure.

FIG. 3 illustrates examples of a route planning technique in accordance with aspects of the present disclosure.

FIGS. 4 through 9 show flowcharts illustrating methods in accordance with aspects of the present disclosure

FIG. 10 shows a diagram of a system including a device in accordance with aspects of the present disclosure.

FIG. 11 shows a diagram of a system including a device in accordance with aspects of the present disclosure.

### DETAILED DESCRIPTION

The techniques described herein facilitate the collection of ‘wet’ signatures in support of a ballot initiative. Wet signatures are produced by making a physical mark on a document for a particular purpose. In many states, legislation requires the use of wet signatures when rallying support for a potential legal change. Depending on the legal requirements in a locale, government officials may need to physically review signatures collected (i.e., audit them) for authenticity and confirming that an adequate number of signatures representative of real individuals were collected. The collection of digital signatures, such as disclosed by Piccionelli (U.S. Pat. No. 7,890,364 B2) is not adequate, nor is the use of devices for the collection of digital signatures, such as disclosed by Grossman (U.S. Pat. No. 9,460,578 B2).

Typical, inefficient approaches taken to collect signatures include soliciting signatures in a public place such as a public gathering place, shopping mall or other venue. This method is perceived as somewhat effective, but citizens may not fully understand a proposed initiative and may be reluctant to disclose personal identifying information. Another frequently employed strategy involves going door to door and asking voters for their support. Both approaches demand significant manpower and expense, and face the challenges of people's schedules and the likelihood of reaching someone who is open to spending time learning about the initiative.

Based on the above, conventional processes of soliciting support are inefficient, and have the potential to present uninterested or non-qualifying individuals with irrelevant information. Conventional approaches are in line with a traditional push model: information is distributed to a large population with the intent of identifying the few that may be interested.

The present disclosure proposes a modular, efficient pull model, by enabling voters to freely register their support and arrange to provide their signature, in contrast with the conventional public solicitation models. The present disclosure is advantageous over previous ballot initiative approaches in that it is a more efficient ‘pull’ based model to solicit signatures versus merely asking for them in support of a ballot initiative. The present disclosure presents both a system and processes to facilitate the collection of signatures in support of ballot initiatives and represents significant efficiency improvements.

In some examples, an initiative may be made available for public review and may be advertised. Prevailing legislation in the United States of America requires that wet signatures be collected in support of a ballot initiative (i.e., not electronic). To do so, the present disclosure enables voters to indicate their support for a ballot initiative through an online medium, such as a web-page, mobile app, or other related and similar channels. A voter's support for a ballot initiative takes the form of a signature collection request.

The signature collection request indicates an individual voter's desire to support a ballot initiative by providing their signature (and accompanying information), and discloses information to be used to coordinate an in-person signature collection in a highly efficient manner. The information nay include information such as the voter's name, preferred date and time to meet, preferred meeting location(s), as well as other pertinent information such as the voter's address, place of work, email address, mobile phone number, or even their GPS coordinates.

Signature collection requests are periodically, or in real-time, provided to collection agents. A collection agent may be a volunteer, hired individual, hired firm, or other person tasked with collecting signatures. Collection agents then use the preferred meeting date, time and locations to meet with individual voters in person to collect signatures. The signature collection request system may additionally examine signature collection requests and provide collection agents with an enhanced (e.g., optimized) collection route. The collection route may guide a collection agent from geographic location to geographic location to meet with voters to collect signatures.

The route may be generated to reduce the cost associated with signature collection. Criteria used to optimize the collection route may be any of the following, combinations thereof, or other related information pertaining to the collection process, such as the time needed to travel to preferred collection locations, the cost associated with travelling to preferred collection locations, the availability of voters at preferred dates and times, the number of collection agents needed to collect a requisite number of signatures, and calendar information such as public holidays, week days versus weekends.

To monitor signature collection progress, the signature collection request system may optionally permit collection agents to indicate the successful or failed collection of signatures. This information is collected, in real-time or in batches, to determine whether the requisite number of signatures associated with a ballot initiative has been collected. When a defined number of signatures have been collected, collection agents are notified to discontinue their collection activities. The defined number of signatures may correspond to a minimum number of signatures to place an initiative on a ballot. The defined number may also exceed the minimum number of signatures by a defined amount (e.g., 5% above the minimum).

In addition to the examples disclosed above, collection agents may also disclose their location to voters who opt in to receive the information, and meet with voters at the disclosed location. This prevents the disclosure of personally identifying location information associated with art individual who prefers not to disclose such information.

Aspects of the disclosure are initially described in the context of a signature collection system and method. Aspects of the disclosure are further illustrated by and described with reference to apparatus diagrams, system diagrams, and flowcharts that relate to signature collection and management in support of public initiatives.

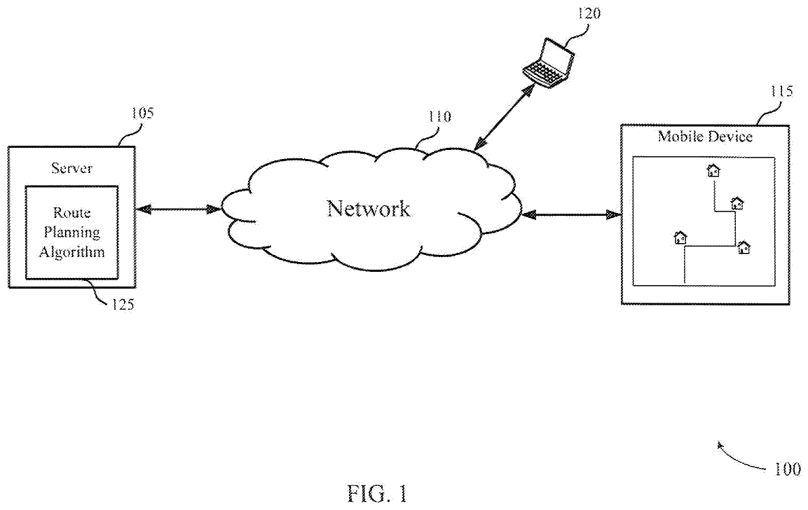

FIG. 1 illustrates an example of a signature collection system 100 in accordance with aspects of the present disclosure. The system 100 includes a server 105, a network 110, a mobile collection agent device 115, and a voter device 120. The server 105, the mobile device 115, and the voter device may communicate with one another via the network 110.

Network 110 may be a communication network (e.g., wireless local area network, wide area network, and the like) permitting wired and/or wireless communication between server 105, mobile, device 115, voter device 120, and other devices. Each of the mobile device 115 and the voter device 120 may be a cellular phone, a personal digital assistant (PDA), a wireless modem, a wireless communication device, a handheld device, a tablet computer, a laptop computer, a cordless phone, a personal electronic device, a handheld device, a personal computer, a wireless local loop (WLL) station, an Internet of things (IoT) device, an Internet of Everything (IoE) device, a machine type communication (MTC) device, an appliance, an automobile, or the like. In some examples, the mobile collection agent device 115 may be a drone or other autonomous vehicle that may have the capability to fly and/or drive.

Server 105 may communicate with the network 110, with another server, with one or more mobile devices 115, with one or more voter devices 120, and with other devices. Server 105 may include a digital storage such as a magnetic disk, an optical disk, flash storage, non-volatile storage, etc. Structured data may be stored in the digital storage such as in a database. Server 105 may have at least one processor that is physically configured to execute computer executable instructions to perform the functions described herein. Server 105 may include non-transitory computer readable media (e.g., volatile memory and/or non-volatile memory) to store the computer executable instructions. Server 105 may be associated with a database. A database may be stored in memory or may be separate. The database may also be part of a cloud of server and may be stored in a distributed manner across a set of servers. Server 105 also may communicate with one or more networks, either through wireless or wired devices. The components of system 100 are examples. System 100 may include additional or fewer components. Also, a function described herein as being performed by a first component may be performed a second component instead or in addition to the first component.

The system 100 may generate a route which a collection agent follows to collect wet signatures in support of a ballot initiative. A ballot initiative is an example of a public initiative. The server 105 may maintain a list of voters that have indicated support for a ballot initiative, and a willingness to provide a signature in support of the ballot initiative. For example, a voter may use voter device 120 to access a publicly available disclosure means, such as a website or mobile application, associated with the server 105, and may electronically indicate support for the ballot initiative. The publicly available disclosure means may indicate the minimum level of support for the ballot initiative minimum number of signatures). The voter may also indicate availability information and a geographic location of the voter in which the voter agrees to be available to provide a wet signature. The server 105 may store a route planning algorithm 125 to generate an enhanced route for signature collection. The route planning algorithm 125 may be a set of computer-executable instructions that are stored in at least one memory and, when executed by at least one processor, may be used to generate a route. The server 105 may store a list of a set of individuals (i.e., voters) indicating support for a public initiative, and may generate a route for a collection agent to collect signatures from that set of voters.

The server 105 may determine a current geographic location of at least one mobile collection agent device 115, and select, from the list, a subset of the individuals based on the current geographic location, the availability information, and the geographic locations associated with the individuals. The server 105 may apply the route generation algorithm to generate a route between geographic locations associated with at least two individuals of the subset of the individuals, and output the route. In some examples, the server 105 may output the route to the mobile collection agent device 115. The mobile collection agent device 115 may guide a collection agent along the route to collect signatures from the voters. In some examples, the mobile collection agent device 115 ma be a drone or other autonomous vehicle that may follow the route to collect signatures from the voters.

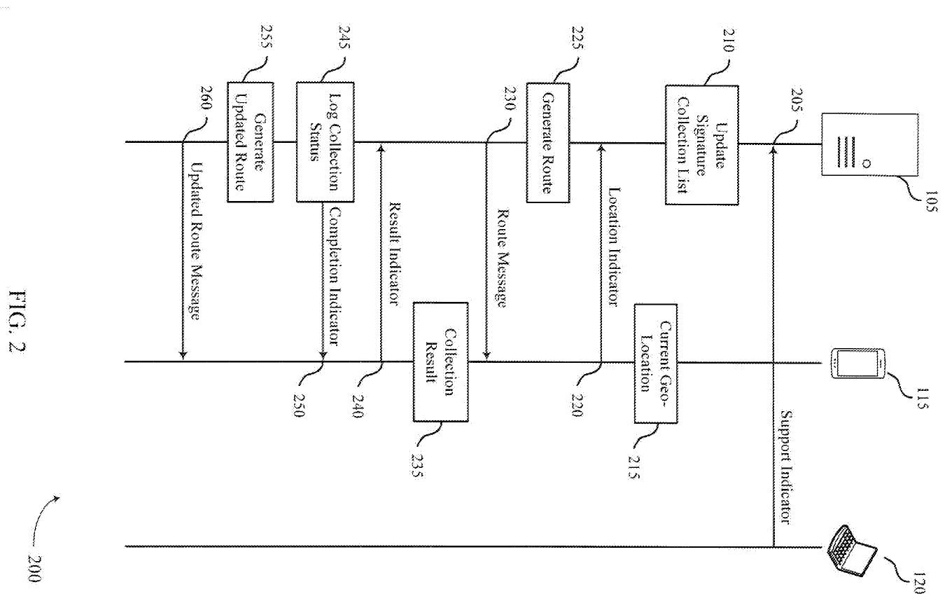

FIG. 2 illustrates an example of a signature collection process flow 200 in accordance with aspects of the present disclosure. In some examples, process flow 200 may implement aspects of system 100. Process flow 200 may include a server 105, a mobile collection agent device 115, and a voter device 120, which may be examples of the devices described with reference to FIG. 1.

In the following description of the process flow 200, the operations between server 105, a mobile collection agent device 115, and a voter device 120 may be performed in different orders or at different times. Certain operations may also be left out of the process flow 200, or other operations may be added to the process flow 200. It is to be understood that while server 105, a mobile collection agent device 115, and a voter device 120 are shown performing a number of the operations of process flow 200, any device may perform the operations shown.

At 205, a user of the voter device 120 may access a website or a mobile application corresponding to the server 105 and transmit a support indicator. The support indicator may indicate the user's name (e.g., full legal name) and that the user is willing to provide a signature in support of a ballot initiative. The support indicator may also include availability information, such as one or more time periods (e.g., one or more timeframe on one or more dates), of when the user is available to sign, and a geographic location at which the user will be at during the one or more time periods (e.g., a preferred signature collection location). While not depicted, other users may similarly use other voter devices (not shown) to access website, mobile application, or the like associated with the server 105 and also transmit support indicators.

At 210, the server 105 may receive the support indicator and update a list of individuals indicating support for the ballot initiative. The list may include the availability information and the geographic location associated with each individual that has indicated a willingness to provide a signature in support of a ballot initiative. In some examples, the server 105 may provide a confirmation message to the voter device 120 to confirm that the support indicator was successfully received. The confirmation message may include, for example, a visual means that the voter may print out to indicate support for the ballot initiative for placement in a publicly visible location to be used by collection agents to easily identify where to meet the voter.

At 215, the device 115 may determine its current geo-location, and, at 220, transmit a location indicator that includes the current geo-location to the server 105. The server 105 may periodically or at least occasionally request that the device 115 provide its current geo-location, or the device 115 may periodically or at least occasionally transmit its current geo-location to the server 105.

At 225, the server 105 may generate a route for the device 115. In an example, the server 105 may select, from the list of individuals indicating support for the ballot initiative, a subset of the individuals on the list based on the current geographic location of device 115, the availability information, and the geographic locations associated with the individuals who indicated support for the ballot initiative. In some examples, the route may be generated between geographic locations associated with at least two individuals, or pairs of individuals, of the subset of the individuals. In some examples, the server 105 may execute the route planning algorithm 125 that considers multiple criteria to generate a route (e.g., an optimal route), including one or more of the following: time needed to travel to a signature collection location, time needed to collect a wet signature, the number of collection agents needed to collect a number of wet signatures, geographic proximity of signature collection requests, or the like, or any combination thereof. The server 105 may generate the route seeking to reduce the number of collection agents required to collect wet signatures and/or to reduce the travel tune needed to collect signatures. Optionally, the server 105 may consider the relative geographic locations of the signature collection requests.

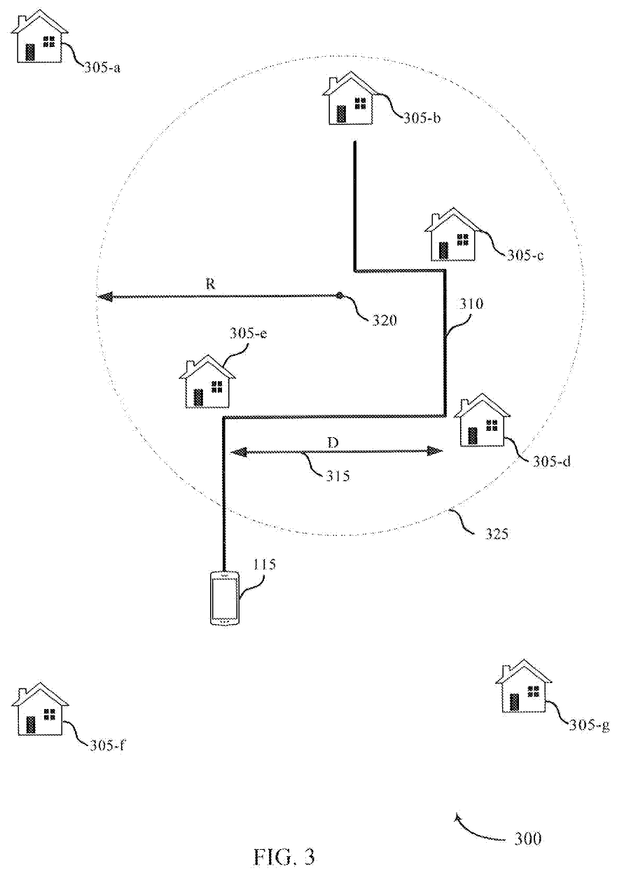

FIG. 3 illustrate examples of a route planning technique 300 in accordance with aspects of the present disclosure. In some examples, route planning technique 300 may implement aspects of system 100. FIG. 3 depicts a set of geographic locations 305-a to 305-f represented in the figure as a set of houses. The geographic locations 305 may, for example, correspond to GPS coordinates, a mailing address, or the like. A geographic location may not necessarily correspond to a building or residence of a voter, and also may include a public place, such as a park, shopping mall, or the like.

In an example, the server 105 nay determine a geographic distance between pairs of the geographic locations 305 associated with individuals that have indicated support for the ballot initiative. For example, the server 105 may calculate a geographic distance between geographic location 305-a and each of geographic locations 305-b to 305-f, a geographic distance between geographic location 305-b and each of geographic locations 305-a and 305-e to 305-f, and so forth. Geographic distance D 315, for example, represents the distance between geographic locations 305-d and 305-e.

The server 105 may select a subset of the individuals from the list based on the determined distances. For example, the server 105 may remove any individual having a shortest determined distance with another individual that exceeds a distance threshold (e.g., due to the individual being too far away from any other individual). The server 105 may then generate a route 310 between the subset of individuals that satisfy the distance threshold. For example, the server 105 may generate route 310 that includes a shortest route between each geographic location 305 between individuals from the subset. The route 310 may in some examples, traverse city streets, highways, interstates, or the like. In some examples, the route 310 may be flight or driving instructions for a drone or other autonomous vehicle between the geographic locations 305.

In an example, the server 105 may generate the route 310 based on a density parameter. The server 105 may, for example, identify a radius R relative to a target geographic location 320 that defines a target geographic region 325, and may identify a density parameter that indicates a number of individuals within the target geographic region 325. The target geographic location 320 may be a location of a mobile device 115 (e.g., its GPS coordinates), or other geographic location. The target geographic region 325 may also be determined in other manners, such as a region defined within a set of GPS coordinates. The server 105 may determine the density parameter for a number of different target geographic regions 325, and may identify a particular one of the target geographic regions 325 that has a density parameter that satisfies a density threshold (e.g., meets or exceeds at least a defined number of voters). The server 105 may then select a subset of the individuals from the list that are within the particular target geographic region 325 that has a density parameter that satisfies a density threshold (e.g., includes a least a defined number of individuals within a 10 mile radius that defines region 325 and have indicated a willingness to sign). The server 105 may then generate a route 310 between the geographic locations of the subset of individuals within the particular target geographic region 325.

In an example, the server 105 may generate the route 310 based on a motivation parameter. The motivation parameter may be, for example, based on historic collection requests relative to prior ballot initiatives for prioritizing geographic regions with a higher likelihood of successful collection requests. For example, some geographic regions may be more responsive to liberal initiatives while others may be of a more conservative proclivity, and the motivation parameter may indicate an expected responsiveness for voters within target geographic region 325 to a particular ballot initiative.

In an example, the server 105 may identify a radius R relative to a target geographic location 320 that defines a target geographic region 325, and may identify a motivation parameter of how likely individuals within the target geographic region 325 will support the ballot initiative. The target geographic region 325 may also be determined in other manners, as described herein.

The server 105 may determine the motivation parameter for a number or different target geographic regions 325, and may identify a particular one of the target geographic regions 325 that has a motivation parameter that satisfies a motivation threshold (e.g., meets or exceeds a motivation threshold). The server 105 may then select a subset of the individuals from the list that are within the particular target geographic region 325 that has a motivation parameter that satisfies a motivation threshold. The server 105 may then generate a route 310 between the geographic locations of the subset of individuals within the particular target geographic region 325.

In some examples, the server 105 may determine whether to generate a route within a target geographic region 325 based on the motivation parameter for region 325. For example, the server 105 may generate a route for the target geographic region 325 provided that the motivation parameter for that target geographic region satisfies a motivation threshold. If the motivation threshold is not satisfied, the server 105 may not generate route for that target geographic region 325. The server 105 may consider other target geographic regions and generate one or more routes for each target geographic region that has a motivation parameter that satisfies the motivation threshold.

In some examples, the server 105 may determine an estimated time to proceed along a set of different routes between the geographic locations 305 within target geographic region 325 the geographic locations of the voters who indicated support within region 325. The server 105 may select a particular route 310 from the set of different routes based on the estimated times (e.g., select the route 310 having the shorted estimated time between the geographic locations 305 of the voters who indicated support within region 325). In some examples, the server 105 may determine each of the estimated times as a function of an estimated amount of time to collect a signature, a current traffic congestion level between pairs of geographic locations 305, art estimated drive time between pairs of the geographic locations 305, or the like, or any combination thereof.

In some examples, the server 105 may estimate an amount of time to collect a defined number of signatures associated with the ballot initiative. For example, the ballot initiative may require a minimum amount of support for the ballot initiative, such as requiring collection of 50,000 signatures. The server 105 may process the geographic locations 305 associated with each of the plurality of individuals, a number of available collections agents, an estimated amount of time to collect a signature, a current traffic congestion level between pairs of geographic locations 305, an estimated drive time between pairs of the geographic locations 305, or the like, or any combination thereof, for estimating the amount of time to collect the defined number of signatures.

With reference again to FIG. 2, at 230, the server 105 may output the generated route to the device 115. For example, the server 105 may cause wireless transmission of a route message that includes the route 310 to the mobile device 115 via a wireless network. In some examples, the route message may cause the mobile device 115 to visually display at least a portion of the route 310. The mobile device 115 may guide a collection agent from geographic location to geographic location attempting to collect signatures from voters along route 310.

At 235, the device 115 may log a result of an attempt to collect a signature from an individual at a particular geographic location 305 and, at 240, the device 115 may transmit a collection result indicator to the server 105. The collection result indicator may indicate whether a collection agent a signature was successfully collected from a particular individual of the subset of the individuals. For example, the collection agent may input into mobile device 115 was able to collect a signature from a voter, and the mobile device 115 may transmit the collection result indicator based on the input.

At 245, the server 105 may receive the collection result indicator and log a collection status. The server 105 may log the collection status to track the number of signatures collected (e.g., in real-time) relating to the minimum number of signatures required for the ballot initiative. In an example, the server 105 may remove, from the list, availability information and geographic location of the particular individual based on the collection result indicator indicating successful collection of a signature from the particular individual. In some examples, the server 105 may add, to a completion list, information of the particular individual based on the collection result indicator indicating successful collection of a signature from the particular individual.

At 250, the server 105 may transmit a completion indicator to the device 115. In an example, the server 105 may determine that a defined number of signatures associated with the ballot initiative have been collected (e.g., determine that at least 50,000 signatures have been collected by summing the received successful collection result indicators). The server 105 may output a complete message to the mobile device 115, as well as other mobile devices 115, to indicate that the defined number of signatures have been collected. The complete message may also indicate to the collection agent to cease collecting signatures.

In some examples, the server 105 may determine that a defined number of signatures have not vet been collected based on the received collection result indicators, and may determine to update a route for one or more mobile devices 115, in an example, at 255, the server 105 may optionally generate an updated route and, at 260, optionally may transmit an updated route message to the device 115. The server 105 may use the techniques described above at 225 to generate the updated route based on the updating to the list at 245, and, in some examples, the route 310 may be updated (e.g., in real-time). The updating may be a function of the success in collecting signatures, as well as the other criteria discussed herein, such as the time needed to travel to a signature collection location, the time needed to collect a wet signature, the number of collection agents needed to collect a number of wet signatures, and the geographic proximity signature collection requests, or the like, or any combination thereof.

The process flow 200, and/or one or more of its operations 205-260, may repeat one or more times. In some examples, the mobile device 115 may be an autonomous vehicle, where the route 310 includes directions for the autonomous vehicle each geographic location included in the route 310. In some examples, the route 310 may include directions for flying the autonomous vehicle from one geographic location to another. In some examples, the mobile device 115 may perform some or all the operations described herein as being performed by the server 105.

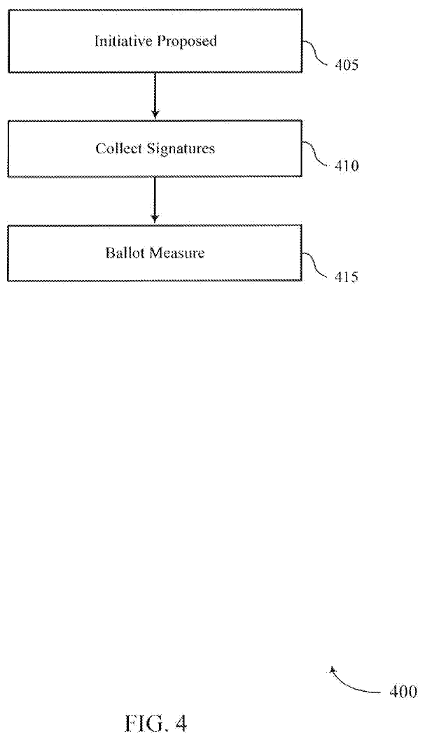

FIG. 4 illustrates a flowchart illustrating a method 400 in accordance with aspects of the present disclosure. The operations of method 400 may be implemented by a mobile device 115 and/or server 105 or their respective components as described herein. In some examples, a mobile device 115 or server 105 may execute a set of instructions to control the functional elements of the mobile device 115 or server 105 to perform the functions described below. Additionally or alternatively, a mobile device 115 or server 105 may perform aspects of the functions described below using special-purpose hardware.

At 405, an initiative may be proposed. Depending on the local government, an initiative may represent various types of proposals, such as the formulation of new legislation, or the repeal of existing legislation. The term initiative may apply to both initiative and referendum, that these terms are legal constructs and processes intended to allow voters to influence law.

At 410, signatures may be collected. Signature collection is a common methodology used to garner support. Traditionally, signature collection has taken many forms, such as setting up tables in public places and explaining proposed initiatives to random passersby, as well as distributing printed information, or soliciting support using online media. The collection process may be engaged in by volunteers, paid collectors or unaffiliated parties. Regardless of the approach, a common element to the techniques is that information about a measure is pushed to the public.

At 415, a ballot measure may speedy collection of a defined number of signatures. Signature collection is engaged in to collect a defined (e.g., minimum) number of signatures in support of an initiative. Each state and local authority may have its own requirements around the minimum level of support required to promote an initiative to a ballot measure. A ballot measure is, as an example, a proposed piece of legislation that has had an adequate level or support ascribed to it through signature collection. A ballot measure appears on a ballot and is presented to all constituents for consideration when voting.

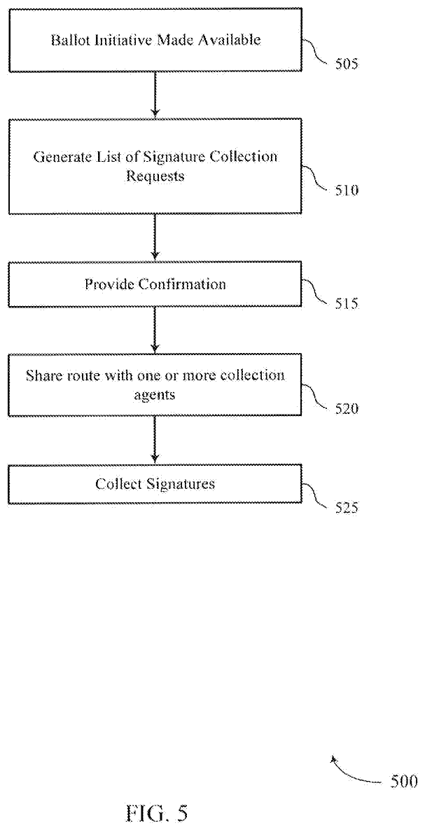

FIG. 5 shows a flowchart illustrating a method 500 in accordance with aspects of the present disclosure. The operations of method 500 may be implemented by a mobile device 115 and/or server 105 or their respective components as described herein. In some examples, a mobile device 115 or server 105 may execute a set of instructions to control the functional elements of the mobile device 115 or server 105 to perform the functions described below. Additionally or alternatively, a mobile device 115 or server 105 may perform aspects of the functions described below using special-purpose hardware.

At 505, a ballot initiative may be made available. After an initiative has been made available, information regarding the initiative is published in a publicly accessible way. As an example, such publication may be in the form of a web page, blog-post, or similar methods of disclosure on, for example, social media sites. Information regarding the initiative may also be distributed in printed form or discussed verbally in a public forum. In addition to the ballot measure initiative, the server 105 may provide a means through which a voter can register their support for the ballot initiative in the form of a signature collection request. A signature collection request may be captured through a web-form, implemented in, but not limited to, the HTML markup language. The signature collection request is captured by a data collection system of server 105. The data collection system tracks the submitted information for later processing and disclosure.

At 510, a list of signature collection requests may be generated. A signature collection request contains information on the ballot initiative under consideration, voter identifying information such as their name, a preferred location, date and time for signature collection. Through disclosure of this information, a voter's signature may be collected at a time convenient to the voter, in contrast to conventional methodology.

At 515, a successful signature collection request may display a confirmation to the voter to indicate that their submission was successful. The confirmation may include an optional visual indicator of which the voter may elect to keep a copy. A voter may display the visual indicator (e.g., in a window, front yard, etc.) to indicate to a collection agent that the voter supports a ballot initiative and is open to meet with the agent for collection of their signature.

At 520, a route may be shared with one or more collection agents. A collection of signature collection requests is shared with one or more collection agents. Collection agents use signature collection requests to guide their collection activities to collect signatures of support from voters in-person.

At 525, signatures may be collected in-person (e.g., to comply with local laws and statutes).

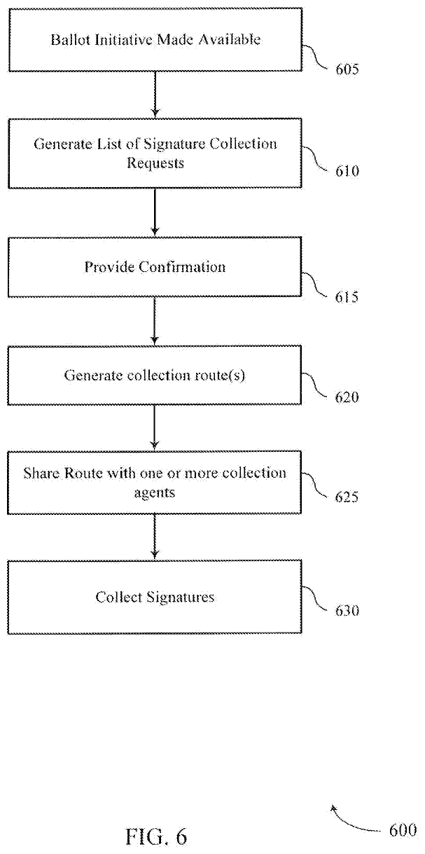

FIG. 6 shows a flowchart illustrating a method 600 in accordance with aspects of the present disclosure. The operations of method 600 may be implemented by a mobile device 115 and/or server 105 or their respective components as described herein. In some examples, a mobile device 115 or server 105 may execute a set of instructions to control the functional elements of the mobile device 115 or server 105 to perform the functions described below. Additionally or alternatively, a mobile device 115 or server 105 may perform aspects of the functions described below using special-purpose hardware.

The method 600 may include the slime operations as method 500, and may additionally include, at 620, generation of a collection route. After the collection of signature collection requests at 610, the server 105 may generate a collection route 310 (e.g., an optimized collection route). A collection route may include a series of instructions provided to collection agents via a mobile device 115 to guide the collection agent for geographic location to geographic location based on the information disclosed by a voter within their associated signature collection request. Based on a preferred date, time, and location for location specified by a votes, server 105 may execute a route planning algorithm to determine a route (e.g., an optimized route) to reduce one or combinations of the following criteria: the number of collection agents needed, the time needed to visit the preferred locations disclosed by voters, the effort, time and cost needed to visit voters at their preferred locations at preferred times, calendar information such as public holidays and weekdays for weekends, or the like, or any combination thereof.

After a route is generated (e.g., an optimized route), the server 105 may at 625 share the route with a mobile device 315 of at least one collection agent for the agent to physically collect signatures. The route 310 may specify that collection of signatures is to take place in the order specified in the route (e.g., in accordance with the one or criteria utilized by the route planning algorithm).

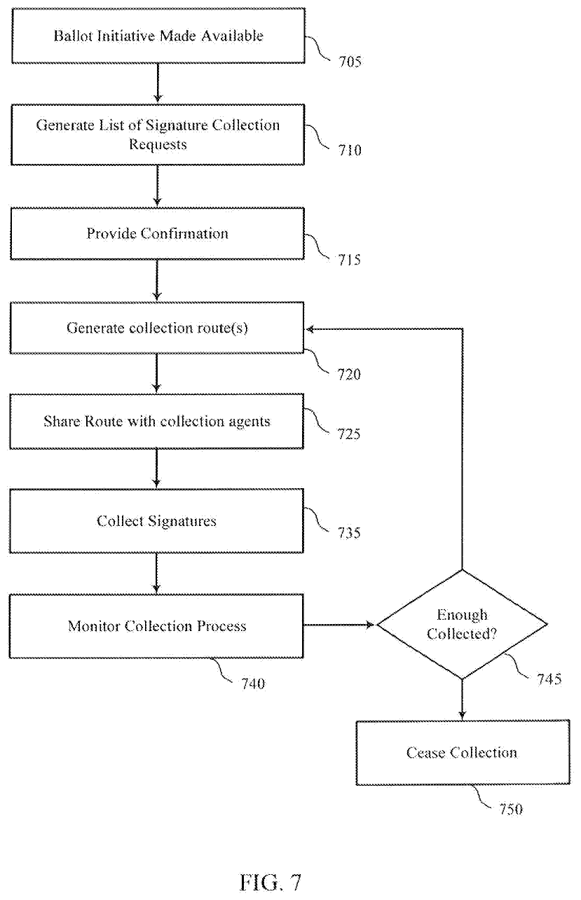

FIG. 7 shows a flowchart illustrating a method 700 in accordance with aspects of the present disclosure. The operations of method 700 may be implemented by a mobile device 115 and/or server 105 or their respective components as described herein. In some examples, a mobile device 115 or server 105 may execute a set of instructions to control the functional elements of the mobile device 115 or server 105 to perform the functions described below. Additionally or alternatively, a mobile device 115 or server 105 may perform aspects of the functions described below using special-purpose hardware.

The method 700 depicts a further example having a real-time monitoring component for tracking the progress of the signature collection process. Operations 705-735 may be the same as operations 605-635 of FIG. 6.

After contacting a voter in response to their signature collection request, a collection agent indicates, via mobile device 115, whether their interaction with the voter resulted in a successful signature collection. The server 105 may, at 740, monitor the collection process (e.g., the number of successfully and/or unsuccessful collection attempts indicated by one or more mobile devices 115). A successful or failed collection attempt results in a collection status. The mobile devices 115 may communicate a result indicator that includes a collection status to the server 105 for updating of a route using the route planning algorithm. A means of communicating the status includes, but is not limited to, an online means such as a website, a mobile application, or the like. The collection status associated with each signature collection request may be used to tally the support associated with each initiative. When an insufficient number or signatures have been collected, the method 700 may return to 745 and the signature collection activities carried out by collection agents may continue. When, at 745, enough signatures have been collected, the method 700 proceeds to 750 and the server 105 informs one or more mobile device to stop collecting signatures. Collection agents may thus be instructed to either continue their efforts or stop collecting signatures through their continual provision of signature collection statuses.

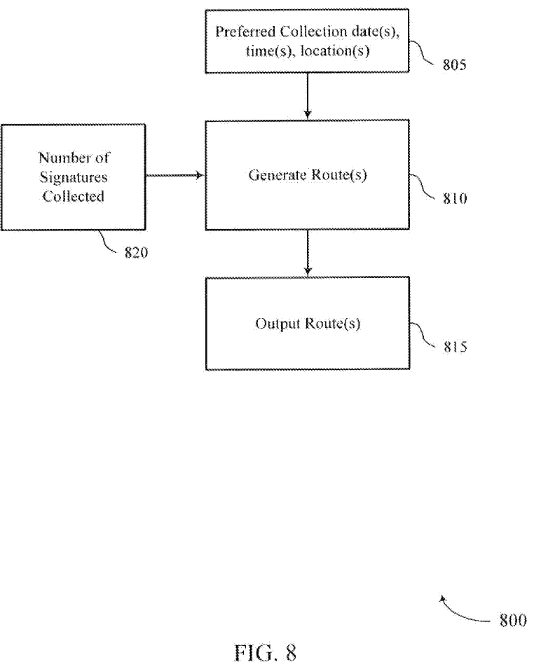

FIG. 8 shows a flowchart illustrating a method 800 in accordance with aspects of the present disclosure. The operations of method 800 may be implemented by a mobile device 115 and/or server 105 or their respective components as described herein. In some examples, a mobile device 115 or server 105 may execute a set of instructions to control the functional elements of the mobile device 115 or server 105 to perform the functions described below. Additionally or alternatively, a mobile device 115 or server 105 may perform aspects of the functions described below using special-purpose hardware.

The method 800 of FIG. 8 illustrates the monitoring of collections progress in real-time. The server 105 may, at 810, potentially generate or adjust a route (e.g., an optimized route) suggested to one or more collection agents, and output one or more routes at 815. The route (e.g., optimal route) may be based on multiple sources of information received at 805, from one or more mobile devices 115 and/or one or more voter devices 120, including, for example, the number of successful and failed signature collection attempts, a newly obtained signature collection request, and their associated preferred collection date, time and locations, or the like, or any combination thereof.

The information collected at 805 by the server 105 may further be used at 820 for reporting purposes. Reports include, but are not limited to, overall number of signatures collected, number of signatures collected by initiative, individual collection agent success rate, voter response rate and tendency, geographical summaries, variations of the above, or any combination thereof. The server 105 may generate a report and transmit the report to one or more mobile devices 115, or other devices.

A further function of the server 105 may be to use historic voting trends to enhance route generation (e.g., for determining optimal collection routes). The route generation criteria described herein may further be enhanced by the motivation parameter that indicates the propensity of a geographic region to respond to initiatives, based on the content of the initiative. For example, some geographic areas may be more responsive to liberal initiatives while others may be of a more conservative proclivity. Generating a route based on the motivation parameter beneficially may reduce the cost impact of collecting signatures in support of an initiative.

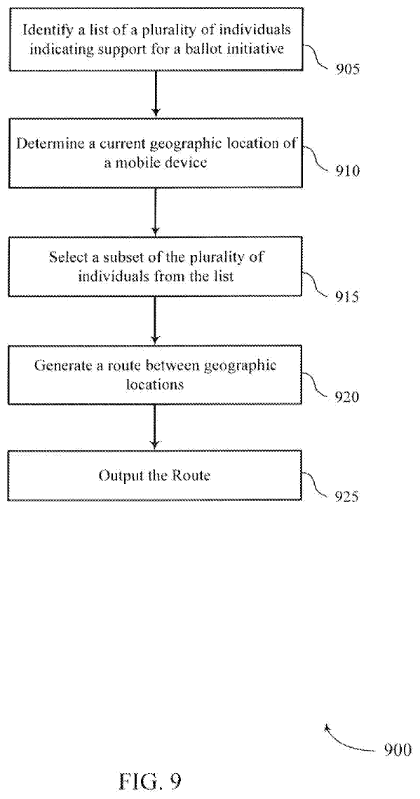

FIG. 9 shows a flowchart illustrating a method 900 in accordance with aspects of the present disclosure. The operations of method 900 may be implemented by a mobile device 115 and/or server 105 or their respective components as described herein. In some examples, a mobile device 115 or server 105 may execute a set of instructions to control the functional elements of the mobile device 115 or server 103 to perform the functions described below. Additionally or alternatively, a mobile device 115 or server 105 may perform aspects of the functions described below using special-purpose hardware.

At 905, the mobile device 115 or server 105 may identify a list of a plurality of individuals indicating support for a ballot initiative, the list including availability information and a geographic location associated with each of the plurality of individuals. The operations of 905 may be performed according to the methods described herein.

At 910, the mobile device 115 or server 105 may determine a current geographic location of the mobile device 115. For example, the mobile device 115 may determine its GPS coordinates, and may send the GPS coordinates to server 105. The operations of 910 may be performed according to the methods described herein.

At 915, the mobile device 115 or server 105 may select, from the list, a subset of the plurality of individuals based on the current geographic location, the availability information, and the geographic locations associated with the plurality of individuals. The operations of 915 may be performed according to the methods described herein.

At 920, the mobile device 115 or server 105 may generate a route between geographic locations associated with at least two individuals of the subset of the plurality of individuals. The operations of 920 may be performed according to the methods described herein.

At 925, the mobile device 115 or server 105 may output the route. In some examples, the mobile device 115 may cause its display screen to visually present the route to, for example, a collection agent. In some examples, the server 105 may output the route by transmitting the route to mobile device 115. The operations of 925 may be performed according to the methods described herein.

It should be noted that the methods described above describe possible implementations, and that the operations and the steps may be rearranged or otherwise modified and that other implementations are possible. Further, aspects from two or more of the methods may be combined.

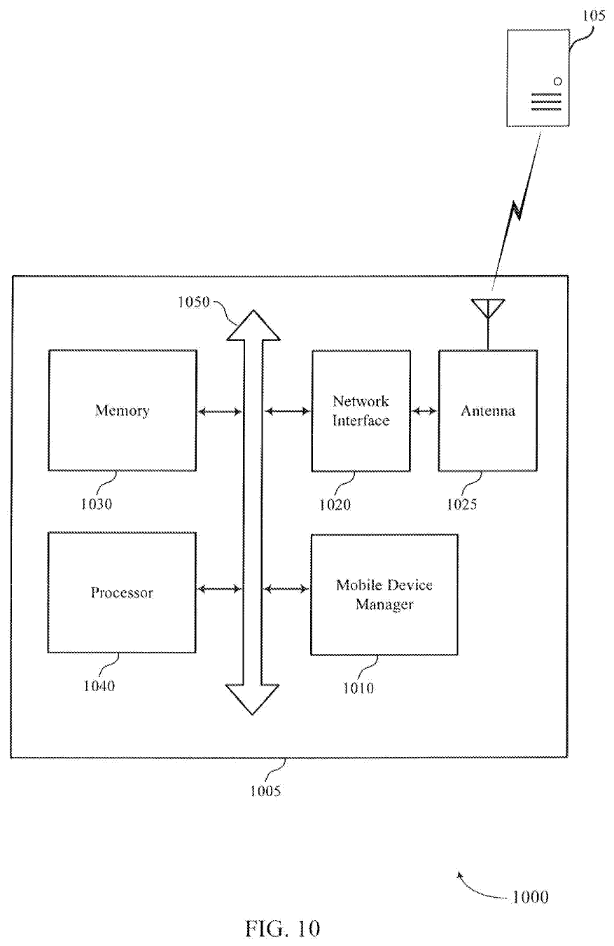

FIG. 10 shows a diagram of a system 1000 including a device 1005 in accordance with aspects of the present disclosure. The device 1005 may be an example of a mobile collection agent device 115 as described herein. The device 1005 may include components for bi-directional communication including components for transmitting and receiving communications, including an mobile device manager 1010, a network interface 1020, an antenna 1025, memory 1030, and a processor 1040. These components may be in electronic communication via one or more buses (e.g., bus 1050).

The mobile device manager 1010 may receive a route message from the server 105 and cause presentation of a route 310 indicated in the route message on its display screen. In some examples, the mobile device manager 1010 may identify a list of a plurality of individuals indicating support for a ballot initiative, the list including availability information and a geographic location associated with each of the plurality of individuals, and determine its current geographic location (e.g., of mobile device 115). The mobile device manager 1010 may select, from the list, a subset of the plurality of individuals based on the current geographic location, the availability information, and the geographic locations associated with the plurality of individuals. The mobile device manager 1010 may generate a route between geographic locations associated with at least two individuals of the subset of the plurality of individuals, and output the route. For example, the mobile device manager 1010 may cause presentation of the route on a display screen of the mobile device 115.

The network interface 1020 may communicate bi-directionally, via one or more antennas, wired, or wireless links as described herein. For example, the network interface 1020 may represent a wireless transceiver and may communicate bi-directionally with another wireless transceiver. In some cases, the wireless device may include an antenna 1025 that may be capable of transmitting or receiving wireless transmissions.

The memory 1030 may include random-access memory (RAM) and read-only memory (ROM). The memory 1030 may store computer-readable, computer-executable code 10 35 including instructions that, when executed, cause the processor to perform various functions described herein. In some cases, the memory 1030 may contain, among other things, a basic input/output system (BIOS) which may control basic hardware or software operation such as the interaction with peripheral components or devices.

The processor 1040 May include an intelligent hardware device, (e.g., a general-purpose processor, a DSP, a CPU, a microcontroller, an ASIC, an FPGA, a PLD, a discrete gate or transistor logic component, a discrete hardware component, or any combination thereof). In some cases, the processor 1040 may be configured to operate a memory array using a memory controller. In other cases, a memory controller may be integrated into processor 1040. The processor 1040 may be configured to execute computer-readable instructions stored in a memory to perform various functions (e.g., functions or tasks supporting signature collection).

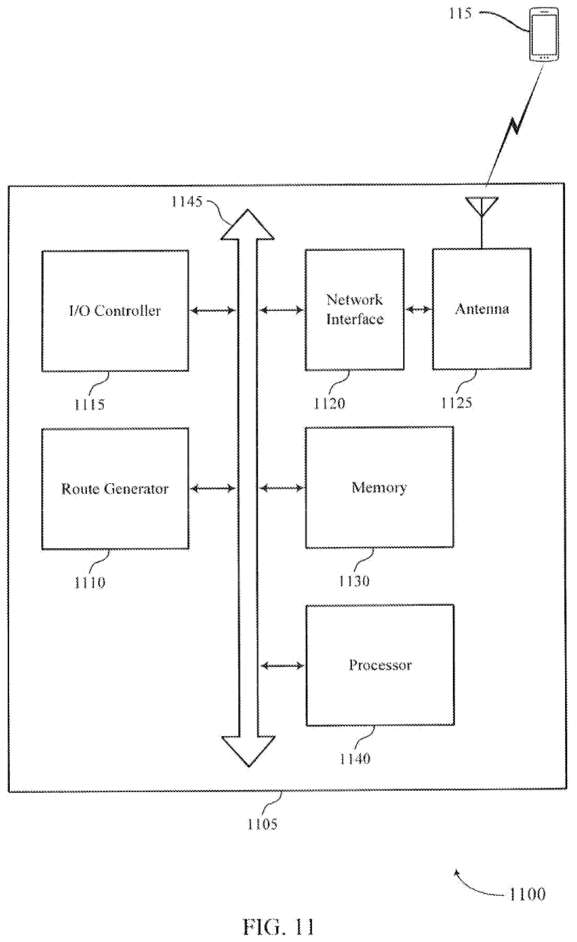

FIG. 11 shows a diagram of a system 1100 in accordance with aspects of the present disclosure. The device 1105 may be an example of a server 105 as described herein. The device 1105 may include components for bi-directional communications including components for transmitting and receiving communications, including a route generator 1110, an I/O controller 1115, a network interface 1120, an antenna 1125, memory 1130, and a processor 1140. These components may be in electronic communication via one or more buses (e.g., bus 1145).

The route generator 1110 may identify a list of a plurality of individuals indicating support for a ballot initiative, the list including availability information and a geographic location associated with each of the plurality of individuals, and determine a current geographic location of a mobile device 115. The route generator 1110 may select, from list, a subset of the plurality of individuals based on the current geographic location, the availability information, and the geographic locations associated with the plurality of individuals. The route generator 1110 may apply a route planning algorithm that generates a route between geographic locations associated with at least two individuals of the subset of the plurality of individuals, and output the route. For example, the route generator 1110 may cause transmission of a route message, or an updated route message, to a mobile device 115.

I/O controller 1115 may manage input and output signals for device 1105. I/O controller 1115 may also manage peripherals not integrated into device 1105. In some cases, I/O controller 1115 may represent a physical connection or port to an external peripheral. In some cases, I/O controller 1115 may utilize an operating system such as iOS®, ANDROID®, MS-DOS®, MS-WINDOWS®, OS/2®, UNIX®, LINUX®, or another known operating system. In other cases, I/O controller 1115 may represent or interact with a modem, a keyboard, a mouse, a touchscreen, or a similar device. In some cases I/O controller 1115 may be implemented as part of a processor. In some cases, a user may interact with device 1105 via I/O controller 1115 or via hardware components controlled by I/O controller 1115.

Network interface 1120 may communicate bi-directionally, via one or more antennas, wired, or wireless links as described above. For example, the network interface 1120 may represent a wireless transceiver and may communicate bi-directionally with another wireless transceiver. The network interface 1120 may also include a modem to modulate the packets and provide the modulated packets to the antennas for transmission, and to demodulate packets received from the antennas. In some cases, the wireless device may include an antenna 1125 capable of transmitting or receiving wireless transmissions.

Memory 1130 may include RAM and ROM. The memory 1130 may store computer-readable, computer-executable software 1135 including instructions that, when executed, cause the processor to perform various functions described herein. In some cases, the memory 1130 may contain, among other things, a BIOS which may control basic hardware or software operation such as the interaction with peripheral components or devices.

Processor 1140 may include an intelligent hardware device, (e.g., a general-purpose processor, a DSP, a CPU, a microcontroller, an ASIC, an FPGA, a PLD, a discrete gate or transistor logic component, a discrete hardware component, or any combination thereof). In some cases, processor 1140 may be configured to operate a memory array using a memory controller. In other cases, a memory controller may be integrated into processor 1140. Processor 1140 may be configured to execute computer-readable instructions stored in a memory to perform various functions (e.g., functions or tasks supporting signature collection).

It should be noted that the methods described above describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, FPGA or other PLD, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include RAM, ROM, electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that cart be accessed by a general-purpose or special-purpose computer, or a general-purpose or special-purpose processor. Also, any connection is properly termed a computer-readable medium. For example, if the software is transmitted front a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least uric of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least impart on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that ma be implemented or that are within the scope of the claims. The term “exemplary” used herein means “serving as an example, instance, or illustration,” and not “preferred” or “advantageous over other examples.” The detailed description includes specific details for the purpose of providing an understanding or the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A computer-implemented method for generating a route for collecting signatures for a public initiative, the method comprising:
identifying a list of a plurality of individuals indicating support for a public initiative, the list including availability information and a geographic location associated with each of the plurality of individuals;
determining a current geographic location of a mobile device;
selecting, from the list, a subset of the plurality of individuals based at least in part on the current geographic location, the availability information, and the geographic locations associated with the plurality of individuals;
generating a route between geographic locations associated with at least two individuals of the subset of the plurality of individuals; and
outputting the route.

2. The method of claim 1, wherein selecting the subset the plurality of individuals further comprises:
determining a distance between a plurality of pairs of the geographic locations associated with the plurality of individuals; and
selecting the subset of the plurality of individuals based at least in part on the determined distances.

3. The method of claim 1, wherein selecting the subset of the plurality of individuals further comprises:
determining a density parameter for a plurality of different geographic regions based at least in part on the geographic locations associated with the plurality of individuals; and
selecting the subset of the plurality of individuals based at least in part on individuals of the subset being located within a particular geographic region of the plurality of different geographic regions associated within a density parameter that satisfies a density threshold.

4. The method of claim 1, wherein selecting the subset of the plurality of individuals further comprises:
determining a motivation parameter associated with a plurality of different geographic regions; and
selecting the subset of the plurality of individuals based at least in part on individuals of the subset being located within a particular geographic region of the plurality of different geographic regions associated within a motivation parameter that satisfies a motivation threshold.

5. The method of claim 1, wherein generating the route further comprises:
determining an estimated time to proceed along a plurality of different routes based at least on the geographic locations associated with the plurality of individuals; and
selecting the route from the plurality of different routes based at least in part on the estimated times.

6. The method of claim 5, where each of the estimated times is determined based at least in part on an estimated amount of time to collect a signature.

7. The method of claim 1, further comprising:
receiving, from the mobile device, a collection result indicator that indicates whether a signature was successfully collected from a particular individual of the subset of the plurality of individuals.

8. The method of claim 7, further comprising:
removing, from the list, availability information and geographic location of the particular individual based at least in part on the collection result indicator indicating successful collection of a signature from the particular individual.

9. The method of claim 7, further comprising:
adding, to a completion list, information of the particular individual based at least in part on the collection result indicator indicating successful collection of a signature from the particular individual.

10. The method of claim 7, further comprising:
determining that a defined number of signatures associated with the public initiative have been collected based at least in part on the collection result indicator; and
outputting a complete message to indicate that the defined number of signatures have been collected.

11. The method of claim 7, further comprising:
determining an updated route based at least in part on the collection result indicator; and
outputting the updated route.

12. The method of claim 1, wherein the availability information indicates a time period and a date.

13. The method of claim 1, wherein the mobile device is an autonomous vehicle, and wherein the route comprises directions between a first geographic location associated with a first individual of the subset of the plurality of individuals and a second geographic location associated with a second individual of the subset of the plurality of individuals.

14. The method of claim 1, wherein the list is generated based at least in part on user input provided via a website or a mobile application.

15. The method of claim 1, wherein outputting the route further comprises:
causing wireless transmission of a route message comprising the route to the mobile device via a wireless network.

16. The method of claim 1, wherein outputting the route further comprises:
causing the mobile device to visually display at least a portion of the route.

17. The method of claim 1, wherein generating the rout further comprises:
generating the route between geographic locations associated with pairs of individuals of the subset of the plurality of individuals.

18. The method of claim 1, further comprising:
estimating an amount of time to collect a defined number of signatures associated with the public initiative based at least in part on the geographic locations associated with each of the plurality of individuals, a number of available collections agents, an estimated amount of time to collect a signature, or any combination thereof.

19. An apparatus for generating a route for collecting signatures for a public initiative, the apparatus comprising:
a processor,
memory in electronic communication with the processor; and
instructions stored in the memory and executable be the processor to cause the apparatus to:
identify a list of a plurality of individuals indicating support for a public initiative, the list including availability information and a geographic location associated with each of the plurality of individuals;
determine a current geographic location of a mobile device;
select, from the list, a subset of the plurality of individuals based at least in part on the current geographic location, the availability information, and the geographic locations associated with the plurality of individuals;
generate a route between geographic locations associated with at least two individuals of the subset of the plurality of individuals; and
output the route.

20. A non-transitory computer-readable medium storing code for generating a route for collecting signatures for a public initiative, the code comprising instructions executable by a processor to:
identify a list of a plurality of individuals indicating support for a public initiative, the list including availability information and a geographic location associated with each of the plurality of individuals;
determine a current geographic location of a mobile device;
select, front the list, a subset of the plurality of individuals based at least in part on the current geographic location, the availability information, and the geographic locations associated with the plurality of individuals;
generate a route between geographic locations associated with at least two individuals of the subset of the plurality of individuals; and
output the route.
